(19) United States
(12) Patent Application Publication
(10) Pub. No.: US 2025/0130829 A1
(43) Pub. Date: Apr. 24, 2025

(54) SYSTEMS AND METHODS FOR SIMULATING HARDWARE DEVICES

(71) Applicant: Dell Products, L.P., Round Rock, TX (US)

(72) Inventors: Jun Gu, Austin, TX (US); Arun Muthaiyan, Round Rock, TX (US); Kang Quan, Austin, TX (US); Sayali Prafulla Kesari, Austin, TX (US)

(73) Assignee: Dell Products, L.P., Round Rock, TX (US)

(21) Appl. No.: 18/490,094

(22) Filed: Oct. 19, 2023

(51) Int. Cl. G06F 9/455

(52) U.S. Cl. CPC G06F 9/45504

(57) ABSTRACT

Embodiments of the present disclosure provide a system and method to simulate hardware devices on an Information Handling System (IHS). According to one embodiment, an Information Handling System (IHS) includes executable instructions to receive, from an application, one or more first messages intended to be sent to a yet-to-be-developed hardware device using at least one software interface associated with the communication links, and generate one or more second messages that simulate a behavior of the missing hardware device. The second message may then be sent to the application to simulate the yet-to-be-developed hardware device.

### BACKGROUND

As the value and use of information continues to increase, individuals and businesses seek additional ways to process and store information. One option available to users is Information Handling Systems (IHSs). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Modern day IHS administrative management is often provided via baseboard management controllers (BMCs). The baseboard management controller (BMC) generally includes a specialized microcontroller embedded in the IHS, and may provide an interface between system-management software and platform hardware. Different types of sensors built into the IHS report to the BMC on parameters such as temperature, cooling fan speeds, power status, operating system (O/S) status, and the like. The BMC monitors the sensors and can send alerts to a system administrator via the network if any of the parameters do not stay within pre-set limits, indicating a potential failure of the system. The administrator can also remotely communicate with the BMC to take certain corrective actions, such as resetting or power cycling the system to get a hung O/S running again. These abilities can often save on the total cost of ownership of an IHS, particularly when implemented in large clusters, such as server farms.

### SUMMARY

Embodiments of the present disclosure provide a system and method to simulate hardware devices on an Information Handling System (IHS). According to one embodiment, an Information Handling System (IHS) includes executable instructions to receive, from an application, one or more first messages intended to be sent to a yet-to-be-developed hardware device using at least one software interface associated with the communication links, and generate one or more second messages that simulate a behavior of the missing hardware device. The second message may then be sent to the application to simulate the yet-to-be-developed hardware device.

According to another embodiment, a hardware device simulation method includes the steps of receiving, from an application configured in an IHS, one or more first messages intended to be sent to the yet-to-be-developed hardware device using at least one of a plurality of software interfaces associated with one or more communication links used by a Baseboard Management Controller (BMC) to manage operation of the yet-to-be-developed hardware device. The method further includes the steps of generating one or more second messages that simulate a behavior of the missing hardware device, and sending the second messages to the application to simulate the yet-to-be-developed hardware device.

According to yet another embodiment, a memory storage device with program instructions stored thereon that, upon execution by one or more processors of an IHS, cause it to receive, from an application, one or more first messages intended to be sent to the yet-to-be-developed hardware device using at least one of a plurality of software interfaces associated with the communication links. The instructions further cause the IHS to generate one or more second messages that simulate a behavior of the missing hardware device, and send the second messages to the application to simulate the yet-to-be-developed hardware device.

### BRIEF DESCRIPTION OF THE DRAWINGS

The present invention(s) is/are illustrated by way of example and is/are not limited by the accompanying figures. Elements in the figures are illustrated for simplicity and clarity, and have not necessarily been drawn to scale.

FIGS. 1A and 1B is a block diagram illustrating certain components of a chassis comprising one or more compute sleds and one or more storage sleds that may be configured to implement the systems and methods described according to one embodiment of the present disclosure.

FIG. 2 illustrates an example of an IHS configured to implement systems and methods described herein according to one embodiment of the present disclosure.

FIG. 3 is a diagram illustrating several components of a hardware device simulation system that may be used to simulate a yet-to-be-developed hardware device on a BMC according to one embodiment of the present disclosure.

FIG. 4 is a diagram showing how the simulation module may be used to simulate messages of a yet-to-be-developed hardware device using software interfaces of a Hardware Abstraction Layer (HAL) according to one embodiment of the present disclosure.

FIG. 5 illustrates another example diagram showing how the simulation module may be used to simulate messages of a yet-to-be-developed hardware device using software interfaces of a kernel space of an IHS according to one embodiment of the present disclosure.

FIG. 6 illustrates an example hardware device simulation method showing how a yet-to-be-developed hardware device may be simulated according to one embodiment of the present disclosure.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

Certain IHSs may be configured with BMCs that are used to monitor, and in some cases manage computer hardware components of their respective IHSs. A BMC is normally programmed using a firmware stack that configures the BMC for performing out-of-band (e.g., external to a computer's operating system or BIOS) hardware management tasks. The BMC firmware can support industry-standard specifications, such as the Intelligent Platform Management Interface (IPMI) and Systems Management Architecture of Server Hardware (SMASH) for computer system administration. The BMC may include a processor, memory, and an out-of-band network interface separate from and physically isolated from an in-band network interface of the IHS, and/or other embedded resources. In certain embodiments, the BMC may include or may be part of a Remote Access Controller (e.g., a DELL Remote Access Controller (DRAC) or an Integrated DRAC (iDRAC)).

The BMC firmware is normally proprietary and is often developed by the vendor and shipped along with the BMC to the end user. Nevertheless, industry trends have migrated toward custom BMC firmware stacks (e.g., operating systems) that allow the end user greater control over how the BMC operates. OpenBMC is one example standard under which custom BMC firmware stacks may be generated. In general, openBMC is a collaborative open-source Linux distribution for BMCs meant to work across heterogeneous systems that include enterprise, high-performance computing (HPC), telecommunications, and cloud-scale data centers.

Advances in BMC design has led to the development implementation of an Inter-Process Communication (IPC) and remote procedure call (RPC) mechanism, such as Desktop Bus (D-Bus), which typically operate outside the operating-system space. D-Bus is usually provided as a “daemon” process that functions in the background to effectively facilitate exchange of IPC messages between processes that provide various services. Implementation of D-Bus in BMCs are advantageous in that it provides for abstraction of invoking interfaces of a service and responding to interface invocations. Thus, the service may be shielded from, among other things, serialization and deserialization of data shared with other services, thus yielding portable services that may be easily migrated from one platform to another. Because D-Bus is a standard feature provided by the openBMC platform, it may be beneficial to re-use established services on other platforms, such as vendor-based platforms, such as Open Server Manager (OMS) provided by DELL TECHNOLOGIES and vice-versa.

Multiple stages exist in the development of BMCs and their related IHSs where different numerous individuals may need to collaborate with each other to validate their various features. For example, personnel, such as engineers, who develop a BMC for a new IHS platform often find a testing environment difficult to find given that many of the hardware devices for the new IHS platform are also currently under development. This problem is exacerbated by the fact that personnel working remotely (e.g., due to pandemic) often yields limitations of physical system access. Even when personnel are physically present, only a limited number of hardware devices may be available to each team of personnel as only basic functionality is often provided, particularly during early development stages. Additionally, changes to the hardware devices and/or delivery delays further limit the nature and quality of testing that may be provided.

In the product validation phase, development teams may have difficulty covering real world customer failures which may not be easily recreated. Additionally for some corner test cases, the tester may not uncover an issue in a regular test environment and would need a special setup or process to trigger a particular failure mode, such as simulating an excessively high temperature in a testing environment. Additionally, if a feature has multiple dependent modules, the dependency between each module may delay feature completion. As such, enabling parallel feature development and validation may be beneficial during development.

Currently, no existing framework exists for simulating hardware devices (e.g., peripheral devices). It would be beneficial to provide a testing framework to simulate hardware devices during development of BMCs along with their associated IHSs. Several interface protocols exist for enabling management of hardware devices by BMCs. For example, a BMC typically uses an I2C bus to manage sensors, PCIe slots, DIMM devices, or other devices such as Power Supply Units (PSUs). The BMC may also use a Serial Peripheral Interface (SPI) link to manage Planar IDs, Riser data, and a General Purpose Input/Output (GPIO) for receiving device presence data. As will be described in detail herein below, embodiments of the present disclosure provide systems and methods for simulating hardware devices using a BMC in which messages sent through communication links used for communication between the BMC and hardware device may be intercepted to generate other messages that may be used to simulate the functionality of yet-to-be-developed hardware devices, such as those that may not yet be available during development.

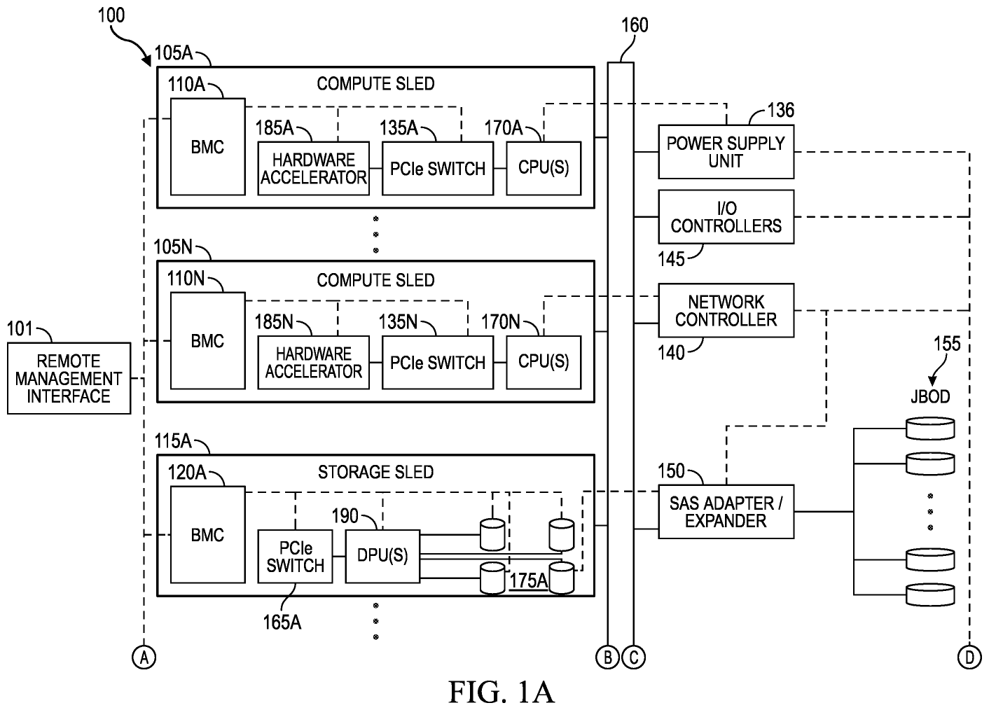

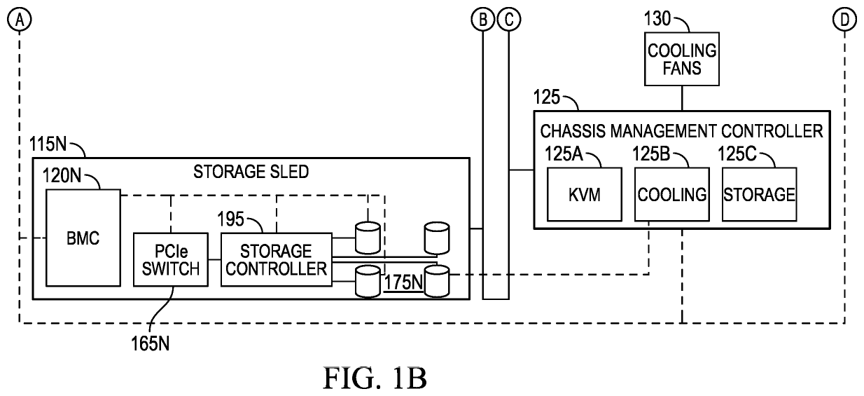

FIGS. 1A and 1B illustrate a block diagram of certain components of a chassis 100 comprising one or more compute sleds 105a-n and one or more storage sleds 115a-n that may be configured to implement the systems and methods described according to one embodiment of the present disclosure. Embodiments of chassis 100 may include a wide variety of hardware configurations in which one or more sleds 105a-n, 115a-n are installed in chassis 100. Such variations in hardware configuration may result from chassis 100 being factory assembled to include components specified by a customer that has contracted for manufacture and delivery of chassis 100. Upon delivery and deployment of a chassis 100, the chassis 100 may be modified by replacing and/or adding various hardware components, in addition to replacement of the removable sleds 105a-n, 115a-n that are installed in the chassis. In addition, once the chassis 100 has been deployed, firmware used by individual hardware components of the sleds 105a-n, 115a-n, or by other hardware components of chassis 100, may be modified in order to update the operations that are supported by these hardware components.

Chassis 100 may include one or more bays that each receive an individual sled (that may be additionally or alternatively referred to as a tray, blade, and/or node), such as compute sleds 105a-n and storage sleds 115a-n. Chassis 100 may support a variety of different numbers (e.g., 4, 8, 16, 32), sizes (e.g., single-width, double-width) and physical configurations of bays. Embodiments may include additional types of sleds that provide various storage, power and/or processing capabilities. For instance, sleds installable in chassis 100 may be dedicated to providing power management or networking functions. Sleds may be individually installed and removed from the chassis 100, thus allowing the computing and storage capabilities of a chassis to be reconfigured by swapping the sleds with diverse types of sleds, in some cases at runtime without disrupting the ongoing operations of the other sleds installed in the chassis 100.

Multiple chassis 100 may be housed within a rack. Data centers may utilize large numbers of racks, with various different types of chassis installed in various configurations of racks. The modular architecture provided by the sleds, chassis and racks allow for certain resources, such as cooling, power, and network bandwidth, to be shared by the compute sleds 105a-n and storage sleds 115a-n, thus providing efficiency improvements and supporting greater computational loads. For instance, certain computational tasks, such as computations used in machine learning and other artificial intelligence systems, may utilize computational and/or storage resources that are shared within an IHS, within an individual chassis 100 and/or within a set of IHSs that may be spread across multiple chassis of a data center.

Implementing computing systems that span multiple processing components of chassis 100 is aided by high-speed data links between these processing components, such as PCIe connections that form one or more distinct PCIe switch fabrics that are implemented by PCIe switches 135a-n, 165a-n installed in the sleds 105a-n, 115a-n of the chassis. These high-speed data links may be used to support algorithm implementations that span multiple processing, networking, and storage components of an IHS and/or chassis 100. For instance, computational tasks may be delegated to a specific processing component of an IHS, such as to a hardware accelerator 185a-n that may include one or more programmable processors that operate separate from the main CPUs 170a-n of computing sleds 105a-n. In various embodiments, such hardware accelerators 185a-n may include DPUs (Data Processing Units), GPUs (Graphics Processing Units), SmartNICs (Smart Network Interface Card) and/or FPGAs (Field Programmable Gate Arrays). These hardware accelerators 185a-n operate according to firmware instructions that may be occasionally updated, such as to adapt the capabilities of the respective hardware accelerators 185a-n to specific computing tasks.

Chassis 100 may be installed within a rack structure that provides at least a portion of the cooling utilized by the sleds 105a-n, 115a-n installed in chassis 100. In supporting airflow cooling, a rack may include one or more banks of cooling fans that may be operated to ventilate heated air from within the chassis 100 that is housed within the rack. The chassis 100 may alternatively or additionally include one or more cooling fans 130 that may be similarly operated to ventilate heated air away from sleds 105a-n, 115a-n installed within the chassis. In this manner, a rack and a chassis 100 installed within the rack may utilize various configurations and combinations of cooling fans 130 to cool the sleds 105a-n, 115a-n and other components housed within chassis 100.

The sleds 105a-n, 115a-n may be individually coupled to chassis 100 via connectors that correspond to the bays provided by the chassis 100 and that physically and electrically couple an individual sled to a backplane 160. Chassis backplane 160 may be a printed circuit board that includes electrical traces and connectors that are configured to route signals between the various components of chassis 100 that are connected to the backplane 160 and between different components mounted on the printed circuit board of the backplane 160. In the illustrated embodiment, the connectors for use in coupling sleds 105a-n, 115a-n to backplane 160 include PCIe couplings that support high-speed data links with the sleds 105a-n, 115a-n. In various embodiments, backplane 160 may support diverse types of connections, such as cables, wires, midplanes, connectors, expansion slots, and multiplexers. In certain embodiments, backplane 160 may be a motherboard that includes various electronic components installed thereon. Such components installed on a motherboard backplane 160 may include components that implement all or part of the functions described with regard to the SAS (Serial Attached SCSI) expander 150, I/O controllers 145, network controller 140, chassis management controller 125 and power supply unit 136.

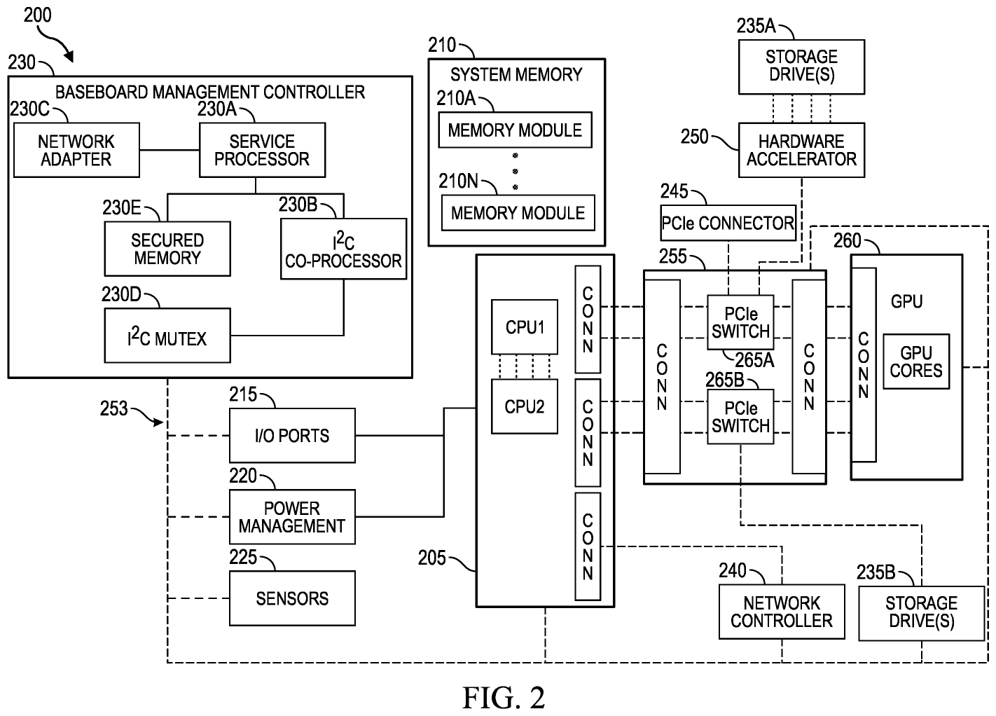

In certain embodiments, each individual sled 105a-n, 115a-n-n may be an IHS such as described with regard to IHS 200 of FIG. 2. Sleds 105a-n, 115a-n may individually or collectively provide computational processing resources that may be used to support a variety of e-commerce, multimedia, business, and scientific computing applications, such as artificial intelligence systems provided via cloud computing implementations. Sleds 105a-n, 115a-n are typically configured with hardware and software that provide leading-edge computational capabilities. Accordingly, services that are provided using such computing capabilities are typically provided as high-availability systems that operate with minimum downtime.

In high-availability computing systems, such as may be implemented using embodiments of chassis 100, any downtime that can be avoided is preferred. As described above, firmware updates are expected in the administration and operation of data centers, but it is preferable to avoid any downtime in making such firmware updates. For instance, in updating the firmware of the individual hardware components of the chassis 100, it is preferable that such updates can be made without having to reboot the chassis. As described in additional detail below, it is also preferable that updates to the firmware of individual hardware components of sleds 105a-n, 115a-n be likewise made without having to reboot the respective sled of the hardware component that is being updated.

As illustrated, each sled 105a-n, 115a-n includes a respective Baseboard Management Controller (BMC) 110a-n, 120a-n also known as a remote access controller (RAC). As described in additional detail with regard to FIG. 2, BMC 110a-n, 120a-n provides capabilities for remote monitoring and management of a respective sled 105a-n, 115a-n and/or of chassis 100. In support of these monitoring and management functions, BMCs 110a-n may utilize both in-band and sideband (i.e., out-of-band) communications with various managed components of a respective sled 105a-n and chassis 100. Remote access controllers 110a-n, 120a-n may collect diverse types of sensor data, such as collecting temperature sensor readings that are used in support of airflow cooling of the chassis 100 and the sleds 105a-n, 115a-n. In addition, each BMC 110a-n, 120a-n may implement various monitoring and administrative functions related to a respective sled 105a-n, 115a-n, where these functions may be implemented using sideband bus connections with various internal components of the chassis 100 and of the respective sleds 105a-n, 115a-n. As described in additional detail below, in various embodiments, these capabilities of the BMCs 110a-n, 120a-n may be utilized in updating the firmware of hardware components of chassis 100 and/or of hardware components of the sleds 105a-n, 115a-n, without having to reboot the chassis or any of the sleds 105a-n, 115a-n.

The BMCs 110a-n, 120a-n that are present in chassis 100 may support secure connections with a remote management interface 101. In some embodiments, remote management interface 101 provides a remote administrator with various capabilities for remotely administering the operation of an IHS, including initiating updates to the firmware used by hardware components installed in the chassis 100. For example, remote management interface 101 may provide capabilities by which an administrator can initiate updates to all of the storage drives 175a-n installed in a chassis 100, or to all of the storage drives 175a-n of a particular model or manufacturer. In some instances, remote management interface 101 may include an inventory of the hardware, software, and firmware of chassis 100 that is being remotely managed through the operation of the BMCs 110a-n, 120a-n. The remote management interface 101 may also include various monitoring interfaces for evaluating telemetry data collected by the BMCs 110a-n, 120a-n. In some embodiments, remote management interface 101 may communicate with BMCs 110a-n, 120a-n via a protocol such the Redfish remote management interface.

In the illustrated embodiment, chassis 100 includes one or more compute sleds 105a-n that are coupled to the backplane 160 and installed within one or more bays or slots of chassis 100. Each of the individual compute sleds 105a-n may be an IHS, such as described with regard to FIG. 2. Each of the individual compute sleds 105a-n may include various different numbers and types of processors that may be adapted to performing specific computing tasks. In the illustrated embodiment, each of the compute sleds 105a-n includes a PCIe switch 135a-n that provides access to a hardware accelerator 185a-n, such as the described DPUs, GPUs, Smart NICs and FPGAs, which may be programmed and adapted for specific computing tasks, such as to support machine learning or other artificial intelligence systems. As described in additional detail below, compute sleds 105a-n may include a variety of hardware components, such as hardware accelerator 185a-n and PCIe switches 135a-n, that operate using firmware that may be occasionally updated.

As illustrated, chassis 100 includes one or more storage sleds 115a-n that are coupled to the backplane 160 and installed within one or more bays of chassis 100 in a similar manner to compute sleds 105a-n. Each of the individual storage sleds 115a-n may include various different numbers and types of storage devices. As described in additional detail with regard to FIG. 2, a storage sled 115a-n may be an IHS 200 that includes multiple solid-state drives (SSDs) 175a-n, where the individual storage drives 175a-n may be accessed through a PCIe switch 165a-n of the respective storage sled 115a-n.

As illustrated, a storage sled 115a may include one or more DPUs (Data Processing Units) 190 that provide access to and manage the operations of the storage drives 175a of the storage sled 115a. Use of a DPU 190 in this manner provides low-latency and high-bandwidth access to numerous SSDs 175a. These SSDs 175a may be utilized in parallel through NVMe transmissions that are supported by the PCIe switch 165a that connects the SSDs 175a to the DPU 190. In some instances, PCIe switch 165a may be an integrated component of a DPU 190. The immense data storage and retrieval capabilities provided by such storage sled 115a implementations may be harnessed by offloading storage operations directed as storage drives 175a to a DPU 190a, and thus without relying on the main CPU of the storage sled, or of any other component of chassis 100. As indicated in FIG. 1, chassis 100 may also include one or more storage sleds 115n that provide access to storage drives 175n via a storage controller 195. In some embodiments, storage controller 195 may provide support for RAID (Redundant Array of Independent Disks) configurations of logical and physical storage drives, such as storage drives provided by storage sled 115n. In some embodiments, storage controller 195 may be a HBA (Host Bus Adapter) that provides more limited capabilities in accessing storage drives 175n.

In addition to the data storage capabilities provided by storage sleds 115a-n, chassis 100 may provide access to other storage resources that may be installed components of chassis 100 and/or may be installed elsewhere within a rack that houses the chassis 100. In certain scenarios, such storage drives 155 may be accessed via a SAS expander 150 that is coupled to the backplane 160 of the chassis 100. The SAS expander 150 may support connections to a number of JBOD (Just a Bunch of Disks) storage drives 155 that, in some instances, may be configured and managed individually and without implementing data redundancy across the various drives 155. The additional storage drives 155 may also be at various other locations within a datacenter in which chassis 100 is installed.

In light of the various manners in which storage drives 175a-n, 155 may be coupled to chassis 100, a wide variety of different storage topologies may be supported. Through these supported topologies, storage drives 175a-n, 155 may be logically organized into clusters or other groupings that may be collectively tasked and managed. In some instances, a chassis 100 may include numerous storage drives 175a-n, 155 that are identical, or nearly identical, such as arrays of SSDs of the same manufacturer and model. Accordingly, any firmware updates to storage drives 175a-n, 155 require the updates to be applied within each of these topologies being supported by the chassis 100. Despite the substantial number of different storage drive topologies that may be supported by an individual chassis 100, the firmware used by each of these storage devices 175a-n, 155 may be occasionally updated. In some instances, firmware updates may be limited to a single storage drive, but in other instances, firmware updates may be initiated for a large number of storage drives, such as for all SSDs installed in chassis 100.

As illustrated, the chassis 100 of FIG. 1 includes a network controller 140 that provides network access to the sleds 105a-n, 115a-n installed within the chassis. Network controller 140 may include various switches, adapters, controllers, and couplings used to connect chassis 100 to a network, either directly or via additional networking components and connections provided via a rack in which chassis 100 is installed. Network controller 140 operates according to firmware instructions that may be occasionally updated.

Chassis 100 may similarly include a power supply unit 135 that provides the components of the chassis with various levels of DC power from an AC power source or from power delivered via a power system provided by a rack within which chassis 100 may be installed. In certain embodiments, power supply unit 135 may be implemented within a sled that may provide chassis 100 with redundant, hot-swappable power supply units. Power supply unit 135 may operate according to firmware instructions that may be occasionally updated.

Chassis 100 may also include various I/O controllers 145 that may support various I/O ports, such as USB ports that may be used to support keyboard and mouse inputs and/or video display capabilities. Each of the I/O controllers 145 may operate according to firmware instructions that may be occasionally updated. Such I/O controllers 145 may be utilized by the chassis management controller 125 to support various KVM (Keyboard, Video and Mouse) 125a capabilities that provide administrators with the ability to interface with the chassis 100. The chassis management controller 125 may also include a storage module 125c that provides capabilities for managing and configuring certain aspects of the storage devices of chassis 100, such as the storage devices provided within storage sleds 115a-n and within the JBOD 155.

In addition to providing support for KVM 125a capabilities for administering chassis 100, chassis management controller 125 may support various additional functions for sharing the infrastructure resources of chassis 100. In some scenarios, chassis management controller 125 may implement tools for managing the power supply unit 135, network controller 140 and airflow cooling fans 130 that are available via the chassis 100. As described, the airflow cooling fans 130 utilized by chassis 100 may include an airflow cooling system that is provided by a rack in which the chassis 100 may be installed and managed by a cooling module 125b of the chassis management controller 125.

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. As described, an IHS may also include one or more buses operable to transmit communications between the various hardware components. An example of an IHS is described in more detail below.

FIG. 2 illustrates an example of an IHS 200 configured to implement systems and methods described herein according to one embodiment of the present disclosure. It should be appreciated that although the embodiments described herein may describe an HIS 200 that is a compute sled or similar computing component that may be deployed within the bays of a chassis, a variety of other types of IHSs 200, such as laptops and portable devices, may also operate according to embodiments described herein. In the illustrative embodiment of FIG. 2, IHS 200 may be a computing component, such as sled 105a-n, 115a-n, or other type of server, such as an 1RU server installed within a 2RU chassis, which is configured to share infrastructure resources provided within a chassis 100.

IHS 200 may utilize one or more system processors 205, that may be referred to as CPUs (central processing units). In some embodiments, CPUs 205 may each include a plurality of processing cores that may be separately delegated with computing tasks. Each of the CPUs 205 may be individually designated as a main processor and as a co-processor, where such designations may be based on delegation of specific types of computational tasks to a CPU 205. In some embodiments, CPUs 205 may each include an integrated memory controller that may be implemented directly within the circuitry of each CPU 205. In some embodiments, a memory controller may be a separate integrated circuit that is located on the same die as the CPU 205. Each memory controller may be configured to manage the transfer of data to and from a system memory 210 of the HIS 200, in some cases using a high-speed memory bus. The system memory 210 is coupled to CPUs 205 via one or more memory buses 205a that provide the CPUs 205 with high-speed memory used in the execution of computer program instructions by the CPUs 205. Accordingly, system memory 210 may include memory components, such as static RAM (SRAM), dynamic RAM (DRAM), NAND Flash memory, suitable for supporting high-speed memory operations by the CPUs 205. In certain embodiments, system memory 210 may combine persistent non-volatile memory and volatile memory.

In certain embodiments, the system memory 210 may be comprised of multiple removable memory modules. The system memory 210 of the illustrated embodiment includes removable memory modules 210a-n. Each of the removable memory modules 210a-n may correspond to a printed circuit board memory socket that receives a removable memory module 210a-n, such as a DIMM (Dual In-line Memory Module), that can be coupled to the socket and then decoupled from the socket as needed, such as to upgrade memory capabilities or to replace faulty memory modules. Other embodiments of IHS system memory 210 may be configured with memory socket interfaces that correspond to diverse types of removable memory module form factors, such as a Dual In-line Package (DIP) memory, a Single In-line Pin Package (SIPP) memory, a Single In-line Memory Module (SIMM), and/or a Ball Grid Array (BGA) memory.

IHS 200 may utilize a chipset that may be implemented by integrated circuits that are connected to each CPU 205. All or portions of the chipset may be implemented directly within the integrated circuitry of an individual CPU 205. The chipset may provide the CPU 205 with access to a variety of resources accessible via one or more in-band buses. IHS 200 may also include one or more I/O ports 215 that may be used to couple the IHS 200 directly to other IHSs, storage resources, diagnostic tools, and/or other peripheral components. A variety of additional components may be coupled to CPUs 205 via a variety of in-line buses. For instance, CPUs 205 may also be coupled to a power management unit 220 that may interface with a power system of the chassis 100 in which IHS 200 may be installed. In addition, CPUs 205 may collect information from one or more sensors 225 via a management bus.

In certain embodiments, IHS 200 may operate using a BIOS (Basic Input/Output System) that may be stored in a non-volatile memory accessible by the CPUs 205. The BIOS may provide an abstraction layer by which the operating system of the IHS 200 interfaces with hardware components of the HIS 200. Upon powering or restarting IHS 200, CPUs 205 may utilize BIOS instructions to initialize and test hardware components coupled to the HIS 200, including both components permanently installed as components of the motherboard of IHS 200 and removable components installed within various expansion slots supported by the IHS 200. The BIOS instructions may also load an operating system for execution by CPUs 205. In certain embodiments, IHS 200 may utilize Unified Extensible Firmware Interface (UEFI) in addition to or instead of a BIOS. In certain embodiments, the functions provided by a BIOS may be implemented, in full or in part, by the BMC 230.

In some embodiments, IHS 200 may include a TPM (Trusted Platform Module) that may include various registers, such as platform configuration registers, and a secure storage, such as an NVRAM (Non-Volatile Random-Access Memory). The TPM may also include a cryptographic processor that supports various cryptographic capabilities. In IHS embodiments that include a TPM, a pre-boot process implemented by the TPM may utilize its cryptographic capabilities to calculate hash values that are based on software and/or firmware instructions utilized by certain core components of HIS 200, such as the BIOS and boot loader of IHS 200. These calculated hash values may then be compared against reference hash values that were previously stored in a secure non-volatile memory of the HIS 200, such as during factory provisioning of IHS 200. In this manner, a TPM may establish a root of trust that includes core components of IHS 200 that are validated as operating using instructions that originate from a trusted source.

As illustrated, CPUs 205 may be coupled to a network controller 240, such as provided by a Network Interface Controller (NIC) card that provides IHS 200 with communications via one or more external networks, such as the Internet, a LAN, or a WAN. In some embodiments, network controller 240 may be a replaceable expansion card or adapter that is coupled to a connector (e.g., PCIe connector of a motherboard, backplane, midplane, etc.) of IHS 200. In some embodiments, network controller 240 may support high-bandwidth network operations by the IHS 200 through a PCIe interface that is supported by the chipset of CPUs 205. Network controller 240 may operate according to firmware instructions that may be occasionally updated.

As indicated in FIG. 2, in some embodiments, CPUs 205 may be coupled to a PCIe card 255 that includes two PCIe switches 265a-b that operate as I/O controllers for PCIe communications, such as TLPs (Transaction Layer Packets), that are transmitted between the CPUs 205 and PCIe devices and systems coupled to IHS 200. Whereas the illustrated embodiment of FIG. 2 includes two CPUs 205 and two PCIe switches 265a-b, different embodiments may operate using different numbers of CPUs and PCIe switches. In addition to serving as I/O controllers that route PCIe traffic, PCIe switches 265a-b include switching logic that can be used to expand the number of PCIe connections that are supported by CPUs 205. PCIe switches 265a-b may multiply the number of PCIe lanes available to CPUs 205, thus allowing more PCIe devices to be connected to CPUs 205, and for the available PCIe bandwidth to be allocated with greater granularity. Each of the PCIe switches 265a-b may operate according to firmware instructions that may be occasionally updated.

Using the available PCIe lanes, the PCIe switches 265a-b may be used to implement a PCIe switch fabric. Also through this switch fabric, PCIe NVMe (Non-Volatile Memory Express) transmission may be supported and utilized in high-speed communications with SSDs, such as storage drives 235a-b, of the IHS 200. Also through this switch fabric, PCIe VDM (Vendor Defined Messaging) may be supported and utilized in managing PCIe-compliant hardware components of the IHS 200, such as in updating the firmware utilized by the hardware components.

As indicated in FIG. 2, IHS 200 may support storage drives 235a-b in various topologies, in the same manner as described with regard to the chassis 100 of FIG. 1. In the illustrated embodiment, storage drives 235a are accessed via a hardware accelerator 250, while storage drives 235b are accessed directly via PCIe switch 265b. In some embodiments, the storage drives 235a-b of IHS 200 may include a combination of both SSD and magnetic disk storage drives. In other embodiments, all of the storage drives 235a-b of IHS 200 may be identical, or nearly identical. In all embodiments, storage drives 235a-b operate according to firmware instructions that may be occasionally updated.

As illustrated, PCIe switch 265a is coupled via a PCIe link to a hardware accelerator 250, such as a DPU, SmartNIC, GPU and/or FPGA, that may be a connected to the IHS via a removable card or baseboard that couples to a PCIe connector of the IHS 200. In some embodiments, hardware accelerator 250 includes a programmable processor that can be configured for offloading functions from CPUs 205. In some embodiments, hardware accelerator 250 may include a plurality of programmable processing cores and/or hardware accelerators, which may be used to implement functions used to support devices coupled to the IHS 200. In some embodiments, the processing cores of hardware accelerator 250 include ARM (advanced RISC (reduced instruction set computing) machine) processing cores. In other embodiments, the cores of the DPUs may include MIPS (microprocessor without interlocked pipeline stages) cores, RISC-V cores, or CISC (complex instruction set computing) (i.e., x86) cores. Hardware accelerator 250 may operate according to firmware instructions that may be occasionally updated.

In the illustrated embodiment, the programmable capabilities of hardware accelerator 250 implement functions used to support storage drives 235a, such as SSDs. In such storage drive topologies, hardware accelerator 250 may implement processing of PCIe NVMe communications with storage drives 235a, thus supporting high-bandwidth connections with the storage drives. Hardware accelerator 250 may also include one or more memory devices used to store program instructions executed by the processing cores and/or used to support the operation of storage drives 235a such as in implementing cache memories and buffers utilized in support of high-speed operation of these storage drives, and in some cases may be used to provide high-availability and high-throughput implementations of the read, write and other I/O operations that are supported by these storage drives 235a. In other embodiments, hardware accelerator 250 may implement operations in support of other types of devices and may similarly support high-bandwidth PCIe connections with these devices. For instance, in various embodiments, hardware accelerator 250 may support high-bandwidth connections, such as PCIe connections, with networking devices in implementing functions of a network switch, compression and codec functions, virtualization operations or cryptographic functions.

As illustrated in FIG. 2, PCIe switches 265a-b may also support PCIe couplings with one or more GPUs (Graphics Processing Units) 260. Embodiments may include one or more GPU cards, where each GPU card is coupled to one or more of the PCIe switches 265a-b, and where each GPU card may include one or more GPUs 260. In some embodiments, PCIe switches 265a-b may transfer instructions and data for generating video images by the GPUs 260 to and from CPUs 205. Accordingly, GPUs 260 may include one or more hardware-accelerated processing cores that are optimized for performing streaming calculation of vector data, matrix data and/or other graphics data, thus supporting the rendering of graphics for display on devices coupled either directly or indirectly to IHS 200. In some instances, GPUs may be utilized as programmable computing resources for offloading other functions from CPUs 205, in the same manner as hardware accelerator 250. GPUs 260 may operate according to firmware instructions that may be occasionally updated.

As illustrated in FIG. 2, PCIe switches 265a-b may support PCIe connections in addition to those utilized by GPUs 260 and hardware accelerator 250, where these connections may include PCIe links of one or more lanes. For instance, PCIe connectors 245 supported by a printed circuit board of IHS 200 may allow various other systems and devices to be coupled to HIS 200. Through couplings to PCIe connectors 245, a variety of data storage devices, graphics processors and network interface cards may be coupled to IHS 200, thus supporting a wide variety of topologies of devices that may be coupled to the IHS 200.

As described, IHS 200 includes a BMC 230 that supports remote management of IHS 200 and of various internal components of IHS 200. In certain embodiments, BMC 230 may operate from a different power plane from the processors 205 and other components of IHS 200, thus allowing the BMC 230 to operate, and management tasks to proceed, while the processing cores of IHS 200 are powered off. Various functions provided by the BIOS, including launching the operating system of the IHS 200, and/or functions of a TPM may be implemented or supplemented by the BMC 230. In some embodiments, the BMC 230 may perform various functions to verify the integrity of the IHS 200 and its hardware components prior to initialization of the operating system of IHS 200 (i.e., in a bare-metal state). In some embodiments, certain operations of the BMC 230, such as the operations described herein for updating firmware used by managed hardware components of IHS 200, may operate using validated instructions, and thus within the root of trust of IHS 200.

In some embodiments, BMC 230 may include a service processor 230a, or specialized microcontroller, which operates management software that supports remote monitoring and administration of IHS 200. The management operations supported by BMC 230 may be remotely initiated, updated, and monitored via a remote management interface 101, such as described with regard to FIG. 1. Remote access controller 230 may be installed on the motherboard of IHS 200 or may be coupled to IHS 200 via an expansion slot or other connector provided by the motherboard. In some instances, the management functions of the BMC 230 may utilize information collected by various managed sensors 225 located within the HIS 200. For instance, temperature data collected by sensors 225 may be utilized by the BMC 230 in support of closed-loop airflow cooling of the IHS 200. As indicated, BMC 230 may include a secured memory 230e for exclusive use by the BMC in support of management operations.

In some embodiments, BMC 230 may implement monitoring and management operations using MCTP (Management Component Transport Protocol) messages that may be communicated to managed devices 205, 235a-b, 240, 250, 255, 260 via management connections supported by a sideband bus 253. In some embodiments, the BMC 230 may additionally or alternatively use MCTP messaging to transmit Vendor Defined Messages (VDMs) via the in-line PCIe switch fabric supported by PCIe switches 265a-b. In some instances, the sideband management connections supported by BMC 230 may include PLDM (Platform Level Data Model) management communications with the managed devices 205, 235a-b, 240, 250, 255, 260 of IHS 200.

As illustrated, BMC 230 may include a network adapter 230c that provides the BMC with network access that is separate from the network controller 240 utilized by other hardware components of the IHS 200. Through secure connections supported by network adapter 230c, BMC 230 communicates management information with remote management interface 101. In support of remote monitoring functions, network adapter 230c may support connections between BMC 230 and external management tools using wired and/or wireless network connections that operate using a variety of network technologies. As a non-limiting example of a BMC, the integrated Dell Remote Access Controller (iDRAC) from Dell® is embedded within Dell servers and provides functionality that helps information technology (IT) administrators deploy, update, monitor, and maintain servers remotely.

Remote access controller 230 supports monitoring and administration of the managed devices of an HIS 200 via a sideband bus interface 253. For instance, messages utilized in device and/or system management may be transmitted using I2C sideband bus 253 connections that may be individually established with each of the respective managed devices 205, 235a-b, 240, 250, 255, 260 of the IHS 200 through the operation of an I2C multiplexer 230d of the BMC. As illustrated in FIG. 2, the managed devices 205, 235a-b, 240, 250, 255, 260 of IHS 200 are coupled to the CPUs 205, either directly or indirectly, via in-line buses that are separate from the 12C sideband bus 253 connections used by the BMC 230 for device management.

In certain embodiments, the service processor 230a of BMC 230 may rely on an I2C co-processor 230b to implement sideband I2C communications between the BMC 230 and the managed hardware components 205, 235a-b, 240, 250, 255, 260 of the IHS 200. The I2C co-processor 230b may be a specialized co-processor or micro-controller that is configured to implement an I2C bus interface used to support communications with managed hardware components 205, 235a-b, 240, 250, 255, 260 of HIS 200. In some embodiments, the I2C co-processor 230b may be an integrated circuit on the same die as the service processor 230a, such as a peripheral system-on-chip feature that may be provided by the service processor 230a. The sideband I2C bus 253 is illustrated as single line in FIG. 2. However, sideband bus 253 may be comprised of multiple signaling pathways, where each may be comprised of a clock line and data line that couple the BMC 230 to I2C endpoints 205, 235a-b, 240, 250, 255, 260.

In various embodiments, an IHS 200 does not include each of the components shown in FIG. 2. In various embodiments, an IHS 200 may include various additional components in addition to those that are shown in FIG. 2. Furthermore, some components that are represented as separate components in FIG. 2 may in certain embodiments instead be integrated with other components. For example, in certain embodiments, all or a portion of the functionality provided by the illustrated components may instead be provided by components integrated into the one or more processor(s) 205 as a systems-on-a-chip.

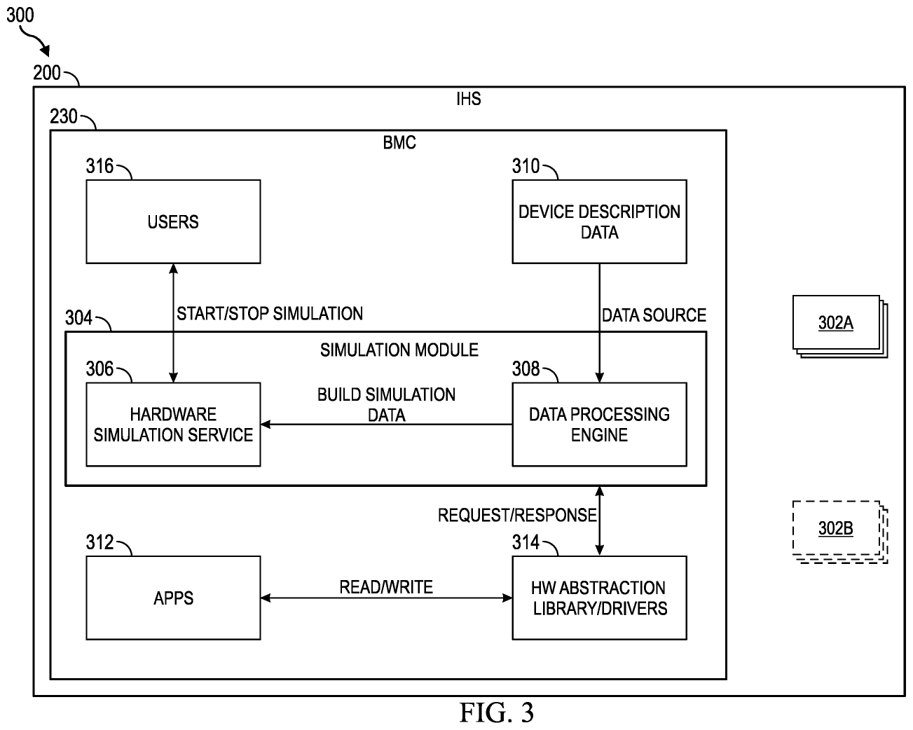

FIG. 3 is a diagram illustrating several components of a hardware device simulation system 300 that may be used to simulate a yet-to-be-developed hardware device on a BMC 230 according to one embodiment of the present disclosure. The hardware device simulation system 300 includes an IHS 200 configured with a BMC 230 and one or more developed hardware devices 302a and/or one or more yet-to-be-developed hardware devices 302b (collectively 302). According to embodiments of the present disclosure, the BMC 230 is configured with a simulation module 304 comprising a hardware simulation service 306 and a data processing engine 308 that may be used to simulate, using device description data 310, the signals generated by the yet-to-be-developed hardware devices 302b, such as, for example, testing or proving in of other systems in the IHS 200 during its development. The device description data 310 stores information about how each yet-to-be-developed hardware device 302b may be modeled by the system 300.

The hardware device simulation system 300 is described herein as being implemented on a BMC 230. Nevertheless, it is contemplated that the hardware device simulation system 300 may be implemented on any computing device (e.g., IHS 200) for which simulation of certain yet-to-be-developed hardware devices 302b are desired.

Within this disclosure, a developed hardware device 302a generally refers to one in which development has been essentially completed, while a yet-to-be-developed hardware device 302b may refer to one in which its development is currently in progress. Examples of yet-to-be-developed devices 302b may include those that are missing or not available for use in the IHS 200, or those whose development is currently undergoing development, such as a partially functioning hardware device. A device with either non-fully functioning hardware or non-fully functioning software, for example, may be considered to be a yet-to-be-developed hardware device 302b. Each of the developed hardware devices 302a and yet-to-be-developed hardware devices 302b may be any type, such as those described above with reference to FIGS. 1A-2.

The simulation module 304 receives from an application 312, one or more messages intended to be sent to a yet-to-be-implemented hardware device 302b using one or more software interfaces 314 (e.g., hardware interface drivers/libraries) associated with one or more communication links, generates one or more second messages that simulate a behavior of the yet-to-be-developed hardware device 302b, and sends the second messages to the application 312. The messages may be any type that is sent between a BMC 230 and the hardware devices 302 of the IHS 200. For example, messages may include requests for data from the yet-to-be-developed hardware device 302b, or commands meant to control the operation of the yet-to-be-developed hardware device 302b. Additionally, the communication links may use any protocol that provides communication between the BMC 230 and the hardware devices 302.

In one embodiment, the hardware simulation service 306 may include a user interface 316 for receiving user input from a user of the hardware device simulation system 300. For example, the hardware simulation service 306 may receive user input for starting or stopping operation of the simulation module 304, or changing how certain yet-to-be-developed hardware device 302b are simulated. Additionally, the user interface 316 may output information to the user about any applications 312 that are currently being executed on the hardware device simulation system 300. Application 312 may be any type. In one embodiment, an application 312 may be a test script used to test or prove in the functionality of some other system in the IHS 200 currently being developed.

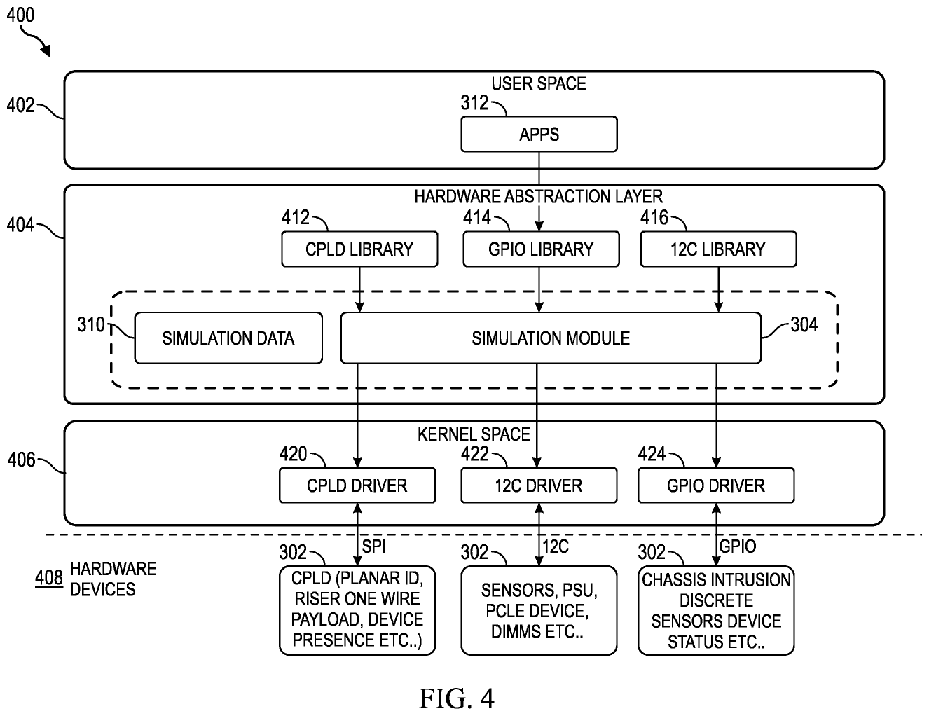

FIG. 4 is a diagram 400 showing how the simulation module 304 may be used to simulate messages of a yet-to-be-developed hardware device 302b using software interfaces of a Hardware Abstraction Layer (HAL) according to one embodiment of the present disclosure. The diagram 400 includes a user space layer 402, a HAL layer 404, a kernel space layer 406, and a hardware device layer 408. The user space layer 402 represents the applications 312 that may be executed during operation of the hardware device simulation system 300.

The HAL layer 404 generally represents executable software that provides the applications 312 with the ability to access hardware devices 302 with a common identical set of interfaces. In the instant case, the HAL layer 404 includes a CPLD library 412, a GPIO library 414, and an I2C library 416 that are each associated with a communication link used by the BMC 230 to communicate with the hardware devices 302. The kernel space layer 406 represents routines or processes that are executed in the kernel space of the OS configured on the IHS 200. As shown, the kernel space 406 includes a CPLD driver 420, a I2C driver 422, and a GPIO driver 424. Although only the CPLD library 412, GPIO library 414, and I2C library 416, CPLD driver 420, I2C driver 422, and GPIO driver 424 are shown, it should be appreciated that the hardware device simulation system 300 may utilize libraries and/or drivers associated with other communication links used by the BMC 230. Examples of other such communication links may include a Management Component Transport Protocol (MCTP) PCIe vendor defined message (VDM) communication link, a I3C SENSEWIRE communication link, a Serial Peripheral Interface (SPI) communication link, or a Keyboard Controller Style (KCS) communication link.

The hardware device layer 408 represents the hardware devices 302 of an IHS 200. Although each hardware device 302 may communicate with the BMC 230 using any suitable interface, certain hardware devices 302 are more likely to be communicated with using certain types. Shown are certain example hardware devices 302 arranged according to their communication link used to communicate with the BMC 230. The CPLD communication link may be used for communicatively coupling the BMC 230 to a Planar ID hardware device 302, a Riser One Wire Payload hardware device 302, a device presence hardware device 302, and the like. The I2C communication link may be used for coupling the BMC 230 to sensor hardware devices 302, PSU hardware device 302, PCIe hardware devices 302, DIMM hardware devices 302, and the like. The GPIO communication link may be used for coupling the BMC 230 to chassis intrusion detection hardware devices 302, discrete sensor hardware devices 302, device status hardware devices 302, and the like.

According to embodiments of the present disclosure, the simulation module 304 may be configured to intercept a first set of messages sent from an application 312 to either of the CPLD library 412, a GPIO library 414, or library 416, and generate a second set of messages that are returned to the application 312 such that a yet-to-be-developed hardware device 302 can be effectively simulated. In one embodiment, logic for determining which second set of messages to generate are provided in a device description file (DDF) 310. The DDF 310 stores information associated with basic characteristics to model the yet-to-be-developed hardware device 302b. The DDF 310 may include device type information, instance number if applicable, simulated protocol information, simulated data information, data location information, associated hardware or firmware dependency information, and additional logic used to simulate the yet-to-be-developed hardware device 302b. The combination of the basic characteristics will cover typical use cases. Simulated protocol information refers to the communication types (e.g., 12C, GPIO, CPLD, etc.) between the BMC 230 and the yet-to-be-developed hardware device 302b. Dependency information could be any condition or state of another hardware device 302 in which the yet-to-be-developed hardware device 302b or any other hardware device 302 could be dependent upon.

For example, if a particular temperature sensor associated with a PSU hardware device 302b is to be simulated, the DDF 310 may include information, such as identifying information about that temperature sensor, the format of telemetry data returned from that device, and the like. The DDF 310 may also include dependency information about the temperature sensor. For example, if another hardware device 302 is to be turned off whenever the temperature measured by that sensor exceeds a certain level (e.g., 135 degrees Fahrenheit), the DDF 310 may be included with logic for simulating that condition.

In one embodiment, the DDF 310 may include information for simulating a particular measured value. For example, the DDF 310 may include information for, when an application 312 issues a request for the temperature value from the temperature sensor described above, the simulation module 304 may respond to the application 312 with that simulated temperature value.

In another embodiment, the simulation module 304 may be included with non-volatile storage (e.g., SD card, etc.) for persisting the simulation data for simulating conditions, such as a system reboot where temporary power loss may occur.

In yet another embodiment, the simulation module 304 may build one or more decision trees based on the DDF 310. The decision tree will be used to quickly determine the appropriate simulation data and logic for the defined test case. By following different decision paths, the simulation data can be user provided or generated by the simulation module 304 based on information included in the DDF 310. The simulation module 304 may also utilize stateful logic to mimic actual hardware actions.

Additional simulation logic or actions can be performed before or after applying the set of simulation data to simulate a specific behavior. The simulation module 304 can also be configured to apply different timing sequences for supporting variation of the simulation data. For example, an application 312 (e.g., a test script) can be executed in which a simulated yet-to-be-developed hardware device 302b responds to a certain change in state to another hardware device 302 at different times (e.g., 100, 300, 500 milliseconds) to test whether other hardware devices 302 in the IHS 200 respond properly based on the response timing of the simulated yet-to-be-developed hardware device 302b.

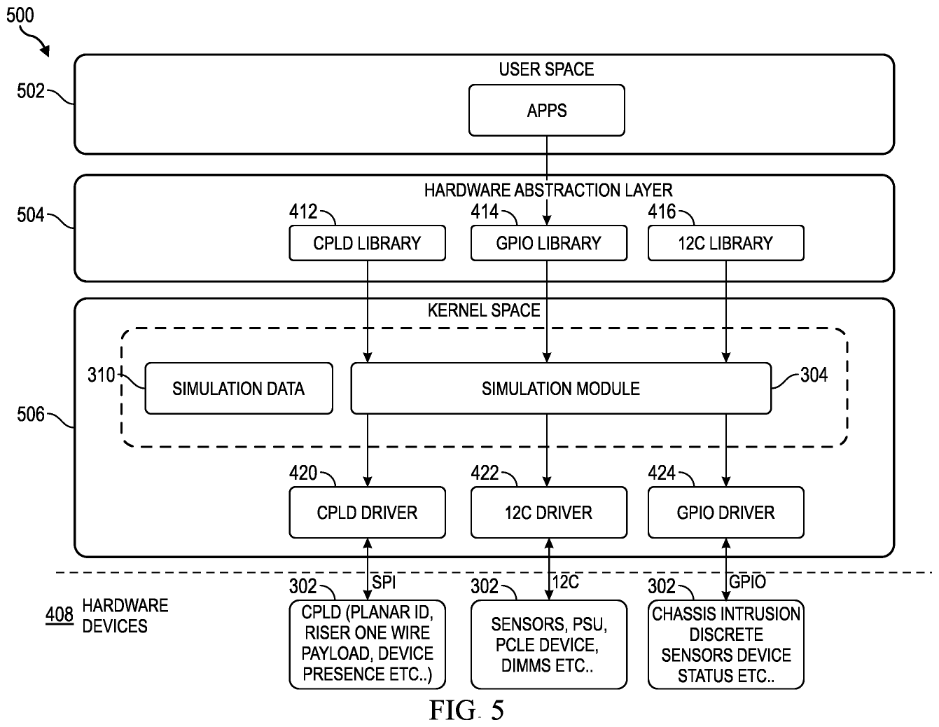

FIG. 5 illustrates another example diagram 500 showing how the simulation module 304 may be used to simulate messages of a yet-to-be-developed hardware device 302b using software interfaces of a kernel space of an IHS 200 according to one embodiment of the present disclosure. The diagram 500 includes a user space layer 502 and a hardware device layer 508 that are similar in design and construction to the user space layer 402 and hardware device layer 408 of FIG. 4. The diagram 500 differs, however, in that the simulation module 304 is configured to interact with drivers 420, 422, 424 in the kernel space layer 506 rather than the HAL layer 404 for simulating a yet-to-be-developed hardware device 302b.

According to embodiments of the present disclosure, the simulation module 304 may be configured to intercept a first set of messages sent from an application 312 to either of the CPLD driver 420, I2C driver 422, or GPIO driver 424, and generate a second set of messages that are returned to the application 312 such that a yet-to-be-developed hardware device 302b can be simulated.

While FIG. 4 shows that the simulation module 304 only interacts with the libraries 412, 414, and 416 in the HAL layer 404, and FIG. 5 shows that the simulation module 304 only interacts with the drivers 420, 422, and 424 in the kernel space layer 506, it should be appreciated that the simulation module 304 may interact with either of the libraries 412, 414, and 416 or the drivers 420, 422, and 424 to simulate a yet-to-be-developed hardware device 302b. To simulate multiple yet-to-be-developed hardware device 302b simultaneously, the simulation module 304 may interact with any combination of libraries 412, 414, and 416 and drivers 420, 422, and 424 to simulate multiple yet-to-be-developed hardware devices 302b.

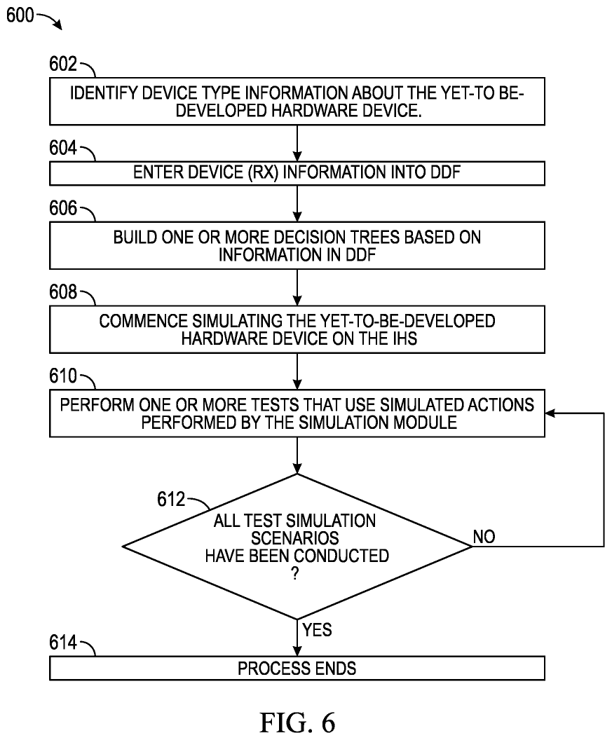

FIG. 6 illustrates an example hardware device simulation method 600 showing how a yet-to-be-developed hardware device 302b may be simulated according to one embodiment of the present disclosure. Additionally or alternatively, the hardware device simulation method 600 may be performed in whole or in part, by the hardware device simulation system 300 as shown and described above with reference to FIG. 3. The hardware device simulation method 600 may be performed any time all or part of a yet-to-be-developed hardware device 302b is to be simulated, such as during a testing phase of product development. In one embodiment, the method 600 may be performed by a test script (e.g., application 3122) executed by the BMC 230 or an external IHS 200.

Initially, a portion of the yet-to-be-developed hardware device 302b to be simulated may be determined. For example, users may wish to simulate the entire functionality of the yet-to-be-developed hardware device 302b or only certain features of the yet-to-be-developed hardware device 302b. Thus, for those features of the yet-to-be-developed hardware device 302b not to be simulated, messages from the application 312 will not be intercepted; rather, they will be forwarded to the yet-to-be-developed hardware device 302b in a normal manner. Although the method 600 is described in terms of a single yet-to-be-developed hardware device 302b, in other embodiments, the method 600 could be performed on multiple yet-to-be-developed hardware devices 302b so that the simulation of multiple yet-to-be-developed hardware devices 302b may be conducted simultaneously.

At step 602, the hardware device simulation method 600 identifies device type information about the yet-to-be-developed hardware device 302b. In one embodiment, the device type information may include information about a communication link that is to be used to provide communication between the BMC 230 and yet-to-be-developed hardware device 302b. The device type information may also include an instance number if applicable, any simulated protocol information, simulated data information, data location information, associated hardware or firmware dependency information, and additional logic used to simulate the yet-to-be-developed hardware device 302b. Thereafter at step 604, the hardware device simulation method 600 enters the device type information into the DDF 310. The DDF 310 may be in any suitable format, such as a file with a ‘dat’ extension. In one embodiment, the DDF 310 is in human-readable form so that the user can easily manipulate the DDF 310 to test differing scenarios. The hardware device simulation method 600 then builds one or more decision trees based on information included in the DDF 310 at step 606.

Steps 602-606 may be performed in total or in part by executable code (e.g., the simulation module 304), or manually by the user. For example, the simulation module 310, or some other executable process, may perform a discovery process to identify the device type information, and process the discovered information to populate the DDF 310 with the device type information. Later on, the user can access the DDF 310 to make certain changes to the device type information stored in the DDF 310 to modify (tweak) how the yet-to-be-developed hardware device 302b is to be simulated.

At step 608, the hardware device simulation method 600 begins simulating the yet-to-be-developed hardware device 302b on the IHS 200. For example, the user, via the user interface 316 may turn the simulation module 304 on so that any ensuing messages sent to the yet-to-be-developed hardware device 302b are filtered through the simulation module 304. At step 610, One or more tests are performed that use simulated actions performed by the simulation module. In one embodiment, the simulation module 304 may receive, from an application (e.g., a test script), one or more messages intended to be sent to a yet-to-be-implemented hardware device using a software interface (e.g., library, driver) associated with the communication link, generate one or more second messages that simulate a behavior of the yet-to-be-developed hardware device 302b, and send the second messages to the application. The tests may be any type that verifies the functionality of some other system in the IHS 200 using the simulated actions performed by the simulation module. For example, the test script may be one executed to test the ability of the BMC 230 to properly respond to certain functionality exhibited by the yet-to-be-developed hardware device 302b.

At step 612, the hardware device simulation method 600 determines whether all test scenarios in the DDF 310 have been conducted. The method 600, for example, may set simulated data of the yet-to-be-developed hardware device 302b or other simulated conditions to new values as specified in the decision tree, and allow the application (e.g., test script) to verify operation when the yet-to-be-developed hardware device 302b is simulated under the newly set conditions. Nevertheless, if all test scenarios have not yet been completed, processing continues at step 610 to continue testing another test scenario using, for example, another simulated functionality of the yet-to-be-developed hardware device 302b. If, however, all test scenarios have been conducted, processing continues at step 614 in which the process ends.

Although FIG. 6 describes an example method 600 that may be performed to simulate a yet-to-be-developed hardware device 302b, the features of the disclosed processes may be embodied in other specific forms without deviating from the spirit and scope of the present disclosure. For example, certain steps of the disclosed method 600 may be performed sequentially, or alternatively, they may be performed concurrently. As another example, the method 600 may perform additional, fewer, or different operations than those operations as described in the present example. As yet another example, the steps of the processes described herein may be performed by an executable process other than the hardware device simulation system 300 as described above.

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS) comprising:
a yet-to-be-developed hardware device;
a Baseboard Management Controller (BMC);
one or more communication links used by the BMC to manage operation of the yet-to-be-developed hardware device;
at least one processor; and
at least one memory coupled to the at least one processor, the at least one memory having program instructions stored thereon that, upon execution by the at least one processor, cause the IHS to:
receive, from an application, one or more first messages intended to be sent to the yet-to-be-developed hardware device using at least one of a plurality of software interfaces associated with the communication links;
generate one or more second messages that simulate a behavior of the missing hardware device; and
send the second messages to the application to simulate the yet-to-be-developed hardware device.

2. The IHS of claim 1, wherein the instructions, upon execution, cause the IHS to obtain device type information about the yet-to-be-developed hardware device;
generate a decision tree according to the obtained device type information; and
simulate the yet-to-be-developed hardware device according to the decision tree.

3. The IHS of claim 2, wherein the instructions, upon execution, cause the IHS to store the device type information in a Device Description File (DDF), wherein the device type information is stored in human-readable form.

4. The IHS of claim 2, wherein the instructions, upon execution, cause the IHS to store the decision tree to be persistent during a re-boot operation of the IHS.

5. The IHS of claim 1, wherein the instructions, upon execution, cause the IHS to simultaneously simulate a plurality of the yet-to-be-developed hardware devices.

6. The IHS of claim 1, wherein the IHS comprises a Baseboard Management Controller (BMC) configured in a server IHS, wherein the yet-to-be-developed hardware device is also configured in the server IHS.

7. The IHS of claim 1, wherein the application comprises a test script.

8. The IHS of claim 1, wherein the instructions, upon execution, cause the IHS to simulate all of the functionality of the yet-to-be-developed hardware device, wherein the yet-to-be-developed hardware device is not available.

9. The IHS of claim 1, wherein the instructions, upon execution, cause the IHS to simulate a portion of the yet-to-be-developed hardware device that is not functional, the remaining portion of the yet-to-be-developed hardware device being functional.

10. A hardware device simulation method comprising:
receiving, from an application configured in an Information Handling System (IHS), one or more first messages intended to be sent to the yet-to-be-developed hardware device using at least one of a plurality of software interfaces associated with one or more communication links used by a Baseboard Management Controller (BMC) to manage operation of the yet-to-be-developed hardware device;
generating one or more second messages that simulate a behavior of the missing hardware device; and
sending the second messages to the application to simulate the yet-to-be-developed hardware device.

11. The hardware device simulation method of claim 10, further comprising:
obtaining device type information about the yet-to-be-developed hardware device;
generating a decision tree according to the obtained device type information; and
simulating the yet-to-be-developed hardware device according to the decision tree.

12. The hardware device simulation method of claim 11, further comprising storing the device type information in a Device Description File (DDF), wherein the device type information is stored in human-readable form.

13. The hardware device simulation method of claim 11, further comprising storing the decision tree to be persistent during a re-boot operation of the IHS.

14. The hardware device simulation method of claim 10, further comprising simultaneously simulating a plurality of the yet-to-be-developed hardware devices.

15. The hardware device simulation method of claim 10, further comprising simulating all of the functionality of the yet-to-be-developed hardware device, wherein the yet-to-be-developed hardware device is not available.

16. The hardware device simulation method of claim 10, further comprising simulating a portion of the yet-to-be-developed hardware device that is not functional, the remaining portion of the yet-to-be-developed hardware device being functional.

17. A memory storage device having program instructions stored thereon that, upon execution by one or more processors of an Information Handling System (IHS), cause the IHS to:
receive, from an application, one or more first messages intended to be sent to the yet-to-be-developed hardware device using at least one of a plurality of software interfaces associated with the communication links;
generate one or more second messages that simulate a behavior of the missing hardware device; and
send the second messages to the application to simulate the yet-to-be-developed hardware device.

18. The memory storage device of claim 17, wherein the instructions, upon execution, cause the IHS to:
obtain device type information about the yet-to-be-developed hardware device;
generate a decision tree according to the obtained device type information; and
simulate the yet-to-be-developed hardware device according to the decision tree.

19. The memory storage device of claim 18, wherein the instructions, upon execution, cause the IHS to store the device type information in a Device Description File (DDF), wherein the device type information is stored in human-readable form.

20. The memory storage device of claim 17, wherein the instructions, upon execution, cause the IHS to simultaneously simulate a plurality of the yet-to-be-developed hardware devices.
